(19) United States
(12) Patent Application Publication
(10) Pub. No.: US 2024/0262128 A1
(43) Pub. Date: Aug. 8, 2024

(54) FREEWHEEL ADAPTER AND FREEWHEEL ASSEMBLY INCLUDING THE SAME

(71) Applicant: RECON CO., LTD., Taichung City (TW)

(72) Inventor: Harry FANG, Taichung City (TW)

(21) Appl. No.: 18/164,165

(22) Filed: Feb. 3, 2023

(51) Int. Cl. B60B 27/04; F16D 41/24

(52) U.S. Cl. CPC B60B 27/047; F16D 41/24

(57) ABSTRACT

A freewheel adapter and a freewheel assembly including the same are provided. The freewheel adapter is configured to be disposed on a driver body of a bicycle, and the driver body is configured to be connected with a bicycle hub and includes a first threaded portion. The freewheel adapter includes a barrel and an annular flange. The barrel includes a first end portion and a second end portion, and an inner peripheral surface of the first end portion has a second threaded portion disposed thereon. The second threaded portion is configured to be screwed with the first threaded portion. The annular flange is disposed on the second end portion and radially protrudes outward beyond an outer peripheral surface of the barrel. The freewheel adapter allows the driver body to be assembled with different types of freewheels.

### BACKGROUND OF THE INVENTION

### Field of the Invention

The present invention relates to a freewheel adapter and a freewheel assembly including the same.

### Description of the Prior Art

According to the connection of a freewheel and a driver body of a hub, the freewheel can be classified under a thread-on freewheel or a cassette. The thread-on freewheel is screwed to an outer thread of the driver body (such as SRAM-XDR driver body) by an inner thread disposed thereon, and the cassette is non-rotatably sleeved to the driver body (such as Shimano driver body) and restricted between the driver body and a cover connected to the driver body. The cassette does not have an inner thread and is engaged with the driver body by splines so that the cassette and the thread-on freewheel have to be used with different types of driver bodies.

When the original thread-on freewheel is replaced with the cassette, the original driver body has to be replaced together. Moreover, the hub also has to be replaced when the driver body is non-detachable from the hub, which is high cost and inconvenient to use.

The present invention is, therefore, arisen to obviate or at least mitigate the above-mentioned disadvantages.

### SUMMARY OF THE INVENTION

The main object of the present invention is to provide a freewheel adapter and a freewheel assembly including the same, which allows a driver body to be assembled with different of types freewheels.

To achieve the above and other objects, the present invention provides a freewheel adapter, configured to be disposed on a driver body of a bicycle. The driver body is configured to be connected with a bicycle hub and includes a first threaded portion. The freewheel adapter includes a barrel and an annular flange. The barrel includes a first end portion and a second end portion axially opposite to each other, and an inner peripheral surface of the first end portion has a second threaded portion disposed thereon. The second threaded portion is configured to be screwed with the first threaded portion. The annular flange is disposed on the second end portion and radially protrudes outward beyond an outer peripheral surface of the barrel.

To achieve the above and other objects, the present invention further provides a freewheel assembly, including the freewheel adapter as described above, further including: a driver body and a freewheel. The driver body is configured to be connected with a bicycle hub and includes a first threaded portion and a second spline portion, and the second threaded portion is screwed with the first threaded portion. The freewheel is sleeved to the driver body and includes a plurality of sprockets comovable with one another and a third spline portion correspondingly engaged with the second spline portion. The annular flange is axially abuttable against an end surface of the freewheel remote from the third spline portion.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a first preferable embodiment of the present invention;

FIG. 2 is a breakdown drawing of the first preferable embodiment of the present invention;

FIG. 3 is another breakdown drawing of the first preferable embodiment of the present invention as viewed from another side;

FIG. 4 is a partial cross-sectional view of the first preferable embodiment of the present invention;

FIG. 5 is a breakdown drawing of a second preferable embodiment of the present invention; and

FIG. 6 is a breakdown drawing of a third preferable embodiment of the present invention.

### DETAILED DESCRIPTION OF THE PREFERRED EMBODIMENTS

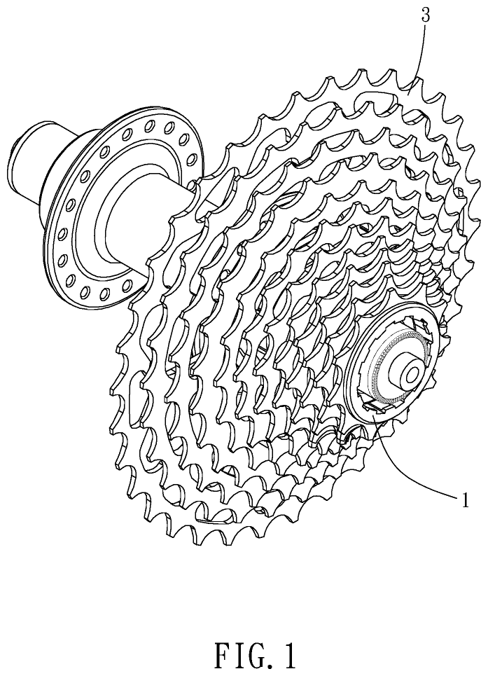

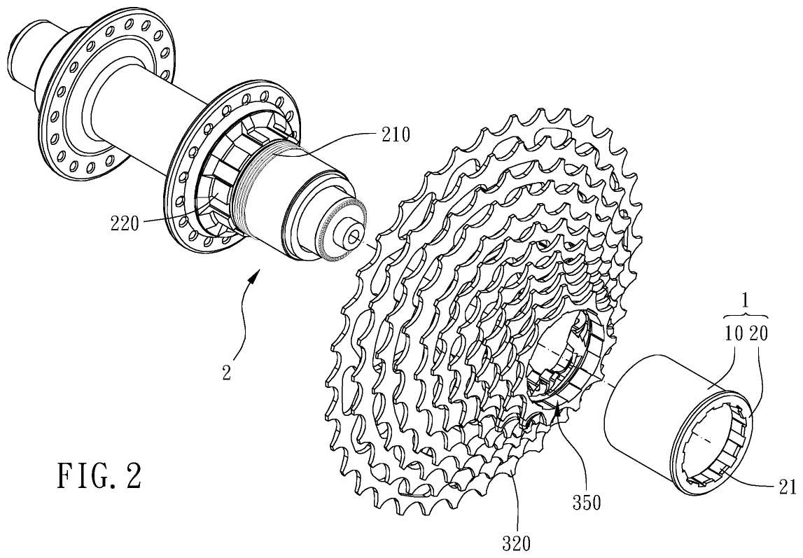

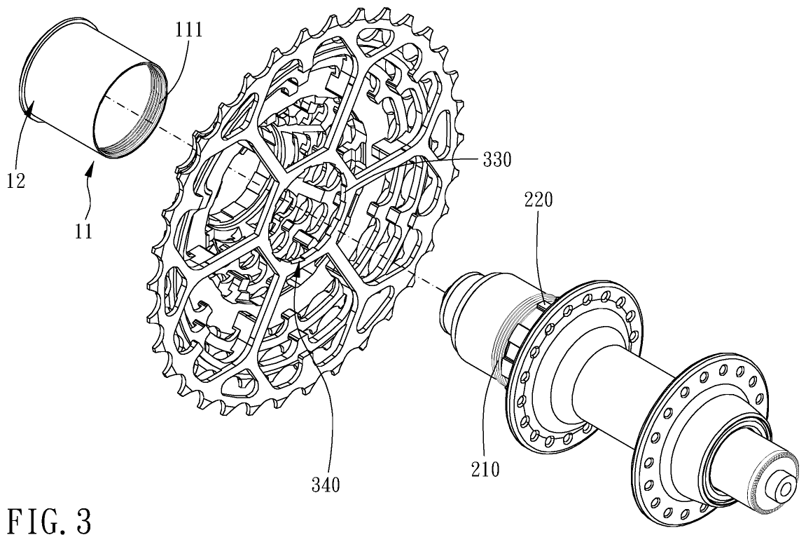

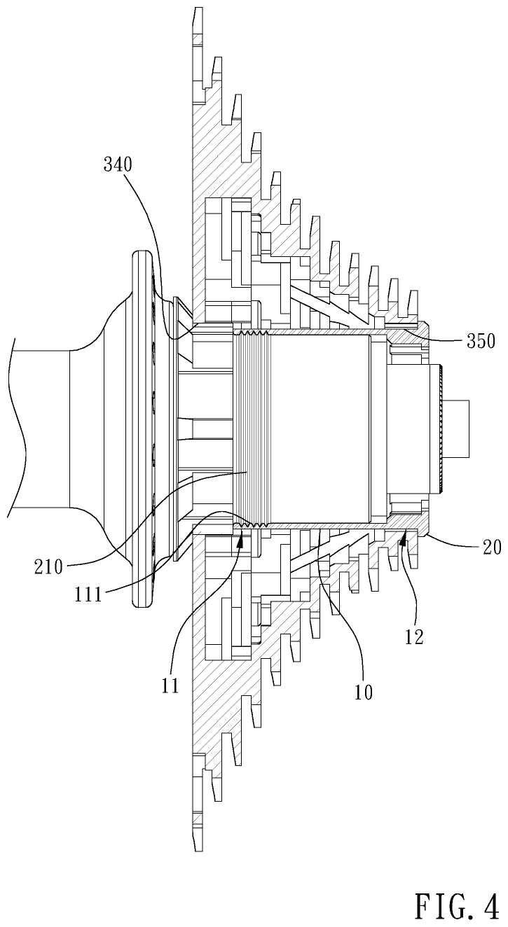

Please refer to FIGS. 1 to 4 for a first preferable embodiment of the present invention. A freewheel adapter 1 of the present invention is configured to be disposed on a driver body 2 of a bicycle, and the driver body 2 is configured to be connected with a bicycle hub and includes a first threaded portion 210. The freewheel adapter 1 includes a barrel 10 and an annular flange 20.

The barrel 10 includes a first end portion 11 and a second end portion 12 axially opposite to each other, and an inner peripheral surface of the first end portion 11 has a second threaded portion 111 disposed thereon. The second threaded portion 111 is screwed with the first threaded portion 210. The annular flange 20 is disposed on the second end portion 12 and radially protrudes outward beyond an outer peripheral surface of the barrel 10. Therefore, the driver body 2 can be assembled with a thread-on freewheel by the existing first threaded portion 210 and be assembled with a cassette by the freewheel adapter 1 without replacement of the driver body 2. For the sake of illustration, the thread-on freewheel refers to a sprocket assembly which is assembled with a driver body by threads, the cassette refers to a sprocket assembly which is assembled with a driver body by splines, and “freewheel” may refer to the thread-on freewheel or/and the cassette.

In this embodiment, the annular flange 20 is integrally formed as a part of the second end portion 12, which is easy to manufacture and provides good structural strength. The barrel 10 has a circular cross-sectional profile and the outer peripheral surface of the barrel 10 has a single diametrical dimension in an axial direction of the barrel 10. In assembling, the cassette is sleeved to the driver body 2, and then the freewheel adapter 1 is sleeved between the cassette and the driver body 2 and screwed to the first threaded portion 210, which provides easy and quick assembling. The freewheel adapter 1 is made of aluminum alloy so as to have light weight and good structural strength. A wall thickness of the barrel 10 is between 0.5 mm and 2.0 mm, which provides sufficient structural strength and allows the barrel 10 to be rotated between the cassette and the driver body 2. In other embodiments, the freewheel adapter may be made of copper, iron, or any other metals and plastics.

Preferably, a width of the annular flange 20 radially protruding beyond the outer peripheral surface of the barrel 10 is larger than or equal to 0.15 mm so as to be stably blocked with the cassette in the axial direction. An inner side of the annular flange 20 has an engaging portion 21 configured to be non-rotatably connected with a removal tool for easy assembling and disassembling.

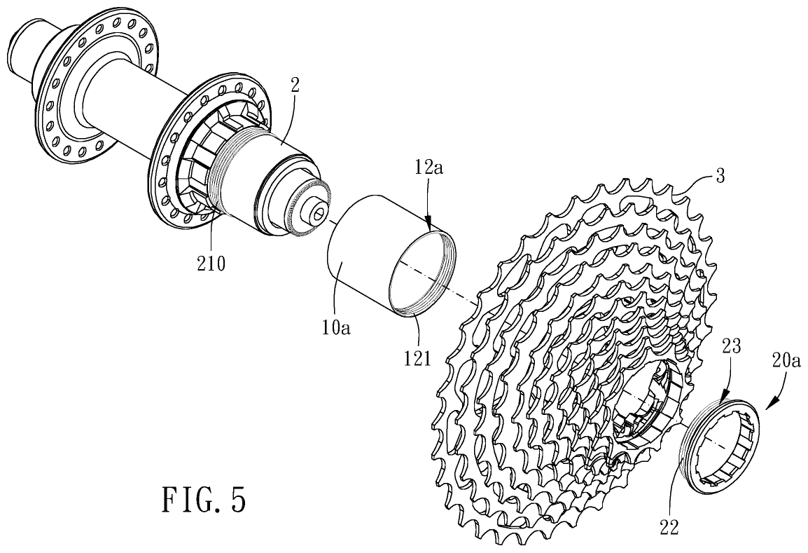

Please refer to a second preferable embodiment of the present invention shown in FIG. 5. The second end portion 12a includes a third threaded portion 121, and the annular flange 20 includes a fourth threaded portion 22 screwed with the third threaded portion 121 for detachable connection. Specifically, the annular flange 20 further includes a sleeving portion 23 extending along an axial direction of the annular flange 20. The third threaded portion 121 is an inner threaded segment disposed on an inner peripheral surface of the second end portion 12, and the fourth threaded portion 22 is an outer threaded segment disposed on an outer peripheral surface of the sleeving portion 23, which has a simple structure and stable assembling and is easy to assemble. In assembling, the barrel 10a is sleeved to the driver body 2 and the second threaded portion 111 is screwed to the first threaded portion 210, the cassette is sleeved to the barrel 10a, then the fourth threaded portion 22 of the annular flange 20a is screwed with the third threaded portion 121. In other way, the barrel 10a may be assembled with the annular flange 20a first and then be sleeved between a freewheel 3 and the driver body 2, which is the same as the first preferable embodiment.

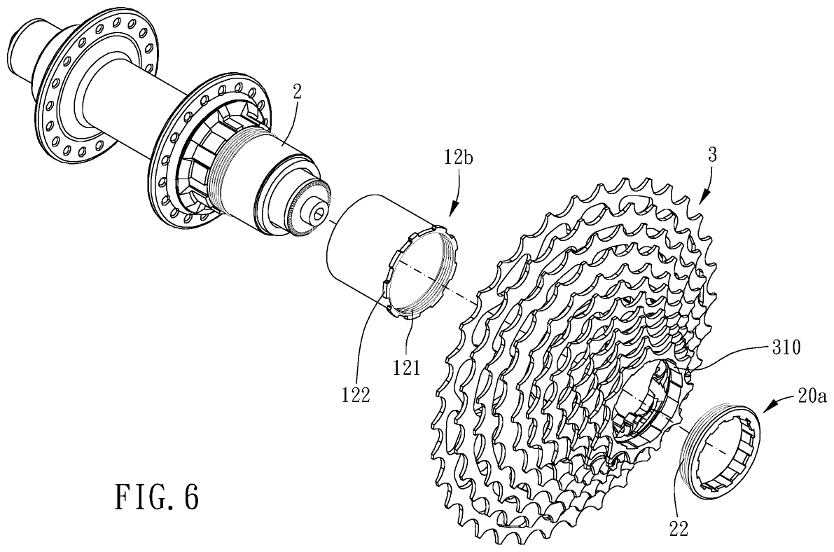

Please refer to a third preferable embodiment of the present invention shown in FIG. 6. The third preferable embodiment differs from the second preferable embodiment in that: an outer peripheral surface of the second end portion 12b preferably has a first spline portion 122 radially protruding therefrom. The first spline portion 122 is configured to be engaged correspondingly with a freewheel 3 of the bicycle (by a spline structure 310 of the existing freewheel) so as to disperse force and provides stable support.

The present invention further provides a freewheel assembly includes the freewheel adapter 1 as described above, further including: the driver body 2 and the freewheel 3. The driver body 2 further includes a second spline portion 220, and the freewheel 3 is sleeved to the driver body 2 and includes a plurality of sprockets 320 comovable with one another and a third spline portion 330 correspondingly engaged with the second spline portion 220. The annular flange 20 is axially abuttable against an end surface of the freewheel 3 remote from the third spline portion 330. In this embodiment, the freewheel 3 is a cassette.

Furthermore, the freewheel 3 includes a first inner peripheral surface 340 and a second inner peripheral surface 350 coaxial with the first inner peripheral surface 340, and the third spline portion 330 is protrudingly disposed on the first inner peripheral surface 340. A difference between an inner diametrical dimension of the second inner peripheral surface 350 and an outer diametrical dimension of the barrel 10 is between 0.1 mm and 0.3 mm, which is convenient to insert the barrel 10 between the freewheel 3 and the driver body 2. The second inner peripheral surface 350 is adjacent to the annular flange 20 and is radially abutted against the outer peripheral surface of the barrel 10 so as to provide radial support and good structural strength.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A freewheel adapter, configured to be disposed on a driver body of a bicycle, the driver body configured to be connected with a bicycle hub and including a first threaded portion, the freewheel adapter including:
a barrel, including a first end portion and a second end portion axially opposite to each other, an inner peripheral surface of the first end portion having a second threaded portion disposed thereon, the second threaded portion being configured to be screwed with the first threaded portion; and
an annular flange, disposed on the second end portion, radially protruding outward beyond an outer peripheral surface of the barrel.

2. The freewheel adapter of claim 1, wherein the annular flange is integrally formed as a part of the second end portion.

3. The freewheel adapter of claim 1, wherein the barrel has a circular cross-sectional profile and the outer peripheral surface of the barrel has a single diametrical dimension in an axial direction of the barrel.

4. The freewheel adapter of claim 1, wherein a wall thickness of the barrel is between 0.5 mm and 2.0 mm.

5. The freewheel adapter of claim 1, wherein a width of the annular flange radially protruding beyond the outer peripheral surface of the barrel is larger than or equal to 0.15 mm.

6. The freewheel adapter of claim 1, wherein an inner side of the annular flange has an engaging portion configured to be non-rotatably connected with a removal tool.

7. The freewheel adapter of claim 1, wherein the second end portion includes a third threaded portion, and the annular flange includes a fourth threaded portion screwed with the third threaded portion.

8. The freewheel adapter of claim 7, wherein an outer peripheral surface of the second end portion has a first spline portion radially protruding therefrom, and the first spline portion is configured to be engaged correspondingly with a freewheel of the bicycle.

9. The freewheel adapter of claim 7, wherein the annular flange further includes a sleeving portion extending along an axial direction of the annular flange, the third threaded portion is an inner threaded segment disposed on an inner peripheral surface of the second end portion, and the fourth threaded portion is an outer threaded segment disposed on an outer peripheral surface of the sleeving portion.

10. A freewheel assembly, including the freewheel adapter of claim 1, further including:
a driver body, configured to be connected with a bicycle hub and including a first threaded portion and a second spline portion, the second threaded portion screwed with the first threaded portion; and
a freewheel, sleeved to the driver body, including a plurality of sprockets comovable with one another and a third spline portion correspondingly engaged with the second spline portion, the annular flange being axially abuttable against an end surface of the freewheel remote from the third spline portion.

11. The freewheel adapter of claim 10, wherein the freewheel includes a first inner peripheral surface and a second inner peripheral surface coaxial with the first inner peripheral surface, the third spline portion is protrudingly disposed on the first inner peripheral surface, and a difference between an inner diametrical dimension of the second inner peripheral surface and an outer diametrical dimension of the barrel is between 0.1 mm and 0.3 mm.

12. The freewheel adapter of claim 11, wherein the second inner peripheral surface is adjacent to the annular flange and is radially abutted against the outer peripheral surface of the barrel.
